(19) United States
(12) Patent Application Publication
(10) Pub. No.: US 2022/0108337 A1
(43) Pub. Date: Apr. 7, 2022

(54) MACHINE LEARNING MODEL BASED RECOMMENDATIONS FOR VEHICLE REMOTE APPLICATION

(71) Applicant: Honda Motor Co., Ltd., Tokyo (JP)

(72) Inventors: Ting Zhang, Torrance, CA (US); David Beltran-del-Rio, Torrance, CA (US)

(21) Appl. No.: 17/061,323

(22) Filed: Oct. 1, 2020

(51) Int. Cl. G06Q 30/02; H04L 29/08; G06N 20/00; G05D 1/00

(52) U.S. Cl. CPC G06Q 30/0205; H04L 67/125; G05D 1/0011; G06Q 30/0201; G06N 20/00

(57) ABSTRACT

A server for machine learning model based recommendations for vehicle remote application is provided. The server includes circuitry configured to retrieve customer subscription data associated with a first set of customers related to a set of vehicles. The set of vehicles are controlled with one or more remote applications associated with the server. The circuitry extracts the first set of features from the customer subscription data and trains a machine learning model based on the first set of features and a first feature of the first set of features. The first feature corresponds to a paid subscription of a remote application. The circuitry determines an importance score for each of the first set of features based on the trained machine learning model. The circuitry generates recommendation information related to the remote application, based on the determined importance score and transmits the recommendation information to electronic devices associated with the server.

### BACKGROUND

Advancements in the fields of information technology and automotive engineering have led to development of various types of services that may be offered to customers of vehicles to remotely control the vehicles. However, certain services may be difficult to sell to the customers of the vehicles, as identification of potential users of such services amongst the customers of the vehicles may be a non-trivial task. Moreover, a dissatisfaction (for example, due to technical issues, a utility of the services, or cost factors) of customers who may be current users of such services may lead to an increase in customer churn and thereby a reduction in revenue of an organization who may sell or market such services.

Limitations and disadvantages of conventional and traditional approaches will become apparent to one of skill in the art, through comparison of described systems with some aspects of the present disclosure, as set forth in the remainder of the present disclosure and with reference to the drawings.

### SUMMARY

An exemplary aspect of the disclosure provides a server for machine learning model based recommendations for vehicle remote application. The server may include circuitry configured to retrieve customer subscription data associated with a first set of customers related to a set of vehicles. The set of vehicles may be controlled with one or more remote applications associated with the server. The circuitry may further extract a first set of features from the retrieved customer subscription data. Furthermore, the circuitry may train a machine learning model based on the extracted first set of features and a first feature of the first set of features. The first feature may correspond to a paid subscription of a remote application of the one or more remote applications. The circuitry may further determine an importance score for each of the extracted first set of features based on the trained machine learning model. Moreover, the circuitry may generate recommendation information related to the remote application, based on the determined importance score for each of the first set of features. The circuitry may further transmit the recommendation information to one or more electronic devices associated with the server.

Another exemplary aspect of the disclosure provides a server for machine learning model based recommendations for vehicle remote application. The server may include circuitry configured to retrieve application usage data. The application usage data may indicate a usage of one or more remote applications by a first set of customers to control a set of vehicles associated with the first set of customers. The circuitry may further generate a second set of features, from a plurality of parameters included in the application usage data. Furthermore, the circuitry may be configured to train a machine learning model based on the generated second set of features and a first feature which may correspond to a paid subscription of a remote application of a remote application of the one or more remote applications. The circuitry may further determine an importance score for each of the generated second set of features based on the trained machine learning model. Furthermore, the circuitry may generate recommendation information related to the remote application, based on the determined importance score for each of the second set of features. The circuitry may be further configured to transmit the recommendation information to one or more electronic devices associated with the server.

Another exemplary aspect of the disclosure provides a method for machine learning model based recommendations for vehicle remote application. The method may include retrieving customer subscription data associated with a first set of customers related to a set of vehicles. The set of vehicles may be controlled with one or more remote applications associated with the server. The method may further include extracting a first set of features from the retrieved customer subscription data. The method may further include training a machine learning model based on the extracted first set of features and a first feature of the first set of features. The first feature may correspond to a paid subscription of a remote application of the one or more remote applications. The method may further include determining an importance score for each of the first set of features based on the trained machine learning model. Furthermore, the method may include generating recommendation information related to the remote application, based on the determined importance score for each of the first set of features. The method may further include transmitting the recommendation information to one or more electronic devices associated with the server.

Another exemplary aspect of the disclosure provides a non-transitory computer-readable medium having stored thereon, computer-executable instructions that when executed by a server, causes the server to execute operations. The operations may include retrieving customer subscription data associated with a first set of customers related to a set of vehicles. The set of vehicles may be controlled with one or more remote applications associated with the server. The operations may further include extracting a first set of features from the retrieved customer subscription data. The operations may further include training a machine learning model based on the extracted first set of features and a first feature of the first set of features. The first feature may correspond to a paid subscription of a remote application of the one or more remote applications. The operations may further include determining an importance score for each of the first set of features based on the trained machine learning model. Furthermore, the operations may include generating recommendation information related to the remote application, based on the determined importance score for each of the first set of features. The operations may further include transmitting the recommendation information to one or more electronic devices associated with the server.

### BRIEF DESCRIPTION OF THE DRAWINGS

FIG. 1 is a diagram that illustrates an exemplary environment for machine learning model based recommendations for vehicle remote application, in accordance with an embodiment of the disclosure.

FIG. 2 is a block diagram of an exemplary server for machine learning model based recommendations for vehicle remote application, in accordance with an embodiment of the disclosure.

FIGS. 3A-3B collectively illustrate exemplary operations for machine learning model based recommendations for vehicle remote application, in accordance with an embodiment of the disclosure.

FIG. 4 illustrates an exemplary table which depicts importance scores for a first set of features and a second set of features, in accordance with an embodiment of the disclosure.

FIG. 5 illustrates a first flowchart of an exemplary method for machine learning model based recommendations for vehicle remote application, in accordance with an embodiment of the disclosure.

FIG. 6 illustrates a second flowchart of an exemplary method for machine learning model based recommendations for vehicle remote application, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed server for generation of recommendation information for a remote application based on a machine learning model. The remote application may be installed on each of a set of customer devices (for example mobile phones) associated with a first set of customers. The remote application (for example an application to control a vehicle remotely) may allow the first set of customers to remotely control their respective vehicles that may be compatible with the remote application. The recommendation information may be generated based on a determination of an impact of a plurality of features (such as a first set of features and/or a second set of features) associated with the first set of customers on a first feature. The first feature may correspond to a paid subscription of the remote application by the first set of customers.

The disclosed server may retrieve customer subscription data associated with the first set of customers. The server may further extract the first set of features from the retrieved customer subscription data. For example, the first set of features may include an age of a first customer, a usage of a free trial of the remote application by the first customer, a model name of a vehicle used by the first customer, and so forth. Advantageously, the first set of features may be extracted to determine an impact of personal information, such as the age of the first customer and the model name of the vehicle used by the first customer on a purchase of the paid subscription of the remote application that may provide a set of services (for example, a remote start service of the vehicle and a remote locking service of the vehicle) associated with the vehicle.

The server may further retrieve application usage data that may indicate a usage of the remote application by the first customer to control the vehicle. The server may generate the second set of features from a plurality of parameters included in the retrieved application usage data. For example, the second set of features may include a rate of success of usage of each service in the remote application and a usage percentage information of each service in the remote application. Advantageously, the second set of features may be generated to determine an impact of the second set of features, such as usage percentage of each service by the first customer on the purchase of the paid subscription of the remote application by the first customer.

The server may further train the machine learning model based on the extracted first set of features and/or the generated second set of features to determine an importance score (or an impact) for each of the first set of features and/or the second set of features. The trained machine learning model may help in the determination of the impact of the first set of features and/or the second set of features associated with the first set of customers on the purchase of the paid subscription of the remote application. For example, the importance score may help in determination of a customer subscription behavior that may further allow an identification of potential customers from the first set of customers (or new customers) that may be more likely to pay for the paid subscription of the remote application. The disclosed server may further control targeted marketing towards such identified potential customers for taking up a paid subscription (or for renewal of existing paid subscription) of the remote application.

The disclosed server may generate the recommendation information that may include marketing information that may help in increase of the paid subscription of the remote application by targeting the potential customers. Thus, the server may allow strategic marketing of the remote application of the one or more remote applications. Moreover, the recommendation information may include information to enhance one or more technical services or capabilities of the remote application based on the determined importance score or impact of the features generated from the application usage data. The enhanced technical services may provide improved experience of the remote application to the first set of customers, thereby, provide a satisfactory experience to the first set of customers, that may enable reduction in a customer churn and sustained or improved revenues for an organization associated with provision of the services and/or the remote application.

Reference will now be made in detail to specific aspects or features, examples of which are illustrated in the accompanying drawings. Wherever possible, corresponding or similar reference numbers will be used throughout the drawings to refer to the same or corresponding parts.

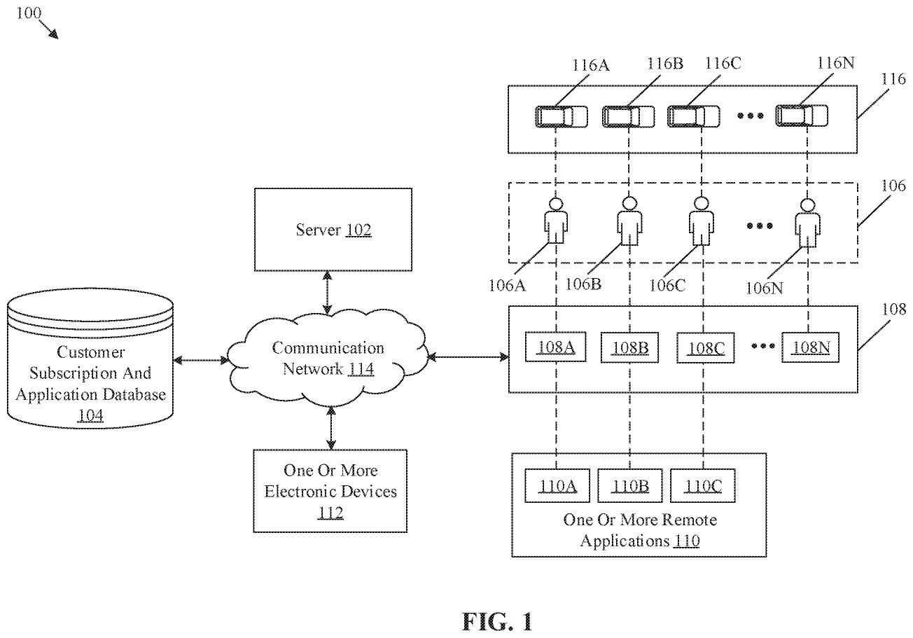

FIG. 1 is a diagram that illustrates an exemplary environment for machine learning based recommendations for vehicle remote application, in accordance with an embodiment of the disclosure. With reference to FIG. 1, there is shown a diagram of an exemplary environment 100. The exemplary environment 100 may include a server 102 and a customer subscription and application database 104. The exemplary environment 100 may further include a first set of customers 106, such as, a first customer 106A, a second customer 106B, a third customer 106C, . . . and an Nth customer 106N. The first set of customers 106 may be associated with a set of vehicles 116, such as, a first vehicle 116A, a second vehicle 116B, a third vehicle 116C, . . . and an Nth vehicle 116N. Each of the first set of customers 106 may be associated with corresponding vehicle of the set of vehicles 116 as shown in FIG. 1. The exemplary environment 100 may further include a set of customer devices 108, such as, a first customer device 108A, a second customer device 108B, a third customer device 108C, . . . and an Nth customer device 108N, which may be associated with the first set of customers 106. One or more customer devices, such as, the first customer device 108A, the second customer device 1086 and the third customer device 108C may include one or more remote applications 110. For example, the first customer device 108A may include a first remote application 110A, the second customer device 1086 may include a second remote application 110B, and the third customer device 108C may include a third remote application 110C associated with the set of vehicles 116. The N number of customers vehicles and customer devices, and remote applications shown in FIG. 1 are presented merely as an example. The exemplary environment 100 may further include one or more electronic devices 112 and a communication network 114. The server 102 may be configured to communicate with the customer subscription and application database 104, the set of customer devices 108, and the one or more electronic devices 112, via the communication network 114.

The server 102 may include suitable logic, circuitry, and interfaces, and/or code that may be configured to train a machine learning model based on a first set of features and/or a second set of features (i.e. associated with one or more of the first set of customers 106 and application usage data related to remote applications), to determine an importance score for each of the first set of features and/or the second set of features. The server 102 may be further configured to generate recommendation information related to a remote application, such as the first remote application 110A of the one or more remote applications 110. The server 102 may be implemented as a cloud server and may execute operations through web applications, cloud applications, HTTP requests, repository operations, file transfer, and the like. Other example implementations of the server 102 may include, but are not limited to, a database server, a file server, a web server, a media server, an application server, a mainframe server, or a cloud computing server. In at least one embodiment, the server 102 may be implemented as a plurality of distributed cloud-based resources by use of several technologies that are well known to those ordinarily skilled in the art.

The set of vehicles 116 may be non-autonomous vehicles, semi-autonomous vehicles, or fully autonomous vehicles. The set of vehicles 116 may be compatible with the one or more remote applications 110. Examples of a vehicle of the set of vehicles 116 may include, but are not limited to, a two-wheeler vehicle, a three-wheeler vehicle, a four-wheeler vehicle, a hybrid vehicle, or a vehicle with autonomous drive capability that may use one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may be a system through which a rider (such as the first customer 106A) may travel from a start point to a destination point. Examples of the four-wheeler vehicle may include, but are not limited to, an electric car, an internal combustion engine (ICE)-based car, a fuel-cell based car, a solar powered-car, or a hybrid car. The present disclosure may be also applicable to other types four-wheelers. The description of other types of the vehicle has been omitted from the disclosure for the sake of brevity.

The customer subscription and application database 104 may include suitable logic, circuitry, interfaces and/or code that may be configured to store the customer subscription data associated with the first set of customers 106. The customer subscription and application database 104 may further store the application usage data which may indicate a usage of the one or more remote applications by the first set of customers 106. The customer subscription and application database 104 may be a relational or a non-relational database that include the customer subscription data and the application usage data. Also, in some cases, the customer subscription and application database 104 may be stored on a server, such as a cloud server or may be cached and stored on the server 102. Additionally, or alternatively, the customer subscription and application database 104 may be implemented using hardware including a processor, a microprocessor (e.g., to perform or control performance of one or more operations), a field-programmable gate array (FPGA), or an application-specific integrated circuit (ASIC). In some other instances, the customer subscription and application database 104 may be implemented using a combination of hardware and software.

The set of customer devices 108 may include suitable logic, circuitry, code and/or interfaces that may be configured to enable the first set of customers 106 to remotely control the respective vehicle of the set of vehicles 116, via the one or more remote applications 110 installed or deployed on the set of customer devices 108. Examples of the set of customer devices 108 may include, but are not limited to, a smartphone, a cellular phone, a mobile phone, a laptop computer, a tablet computer, a desktop computer, a mainframe machine, a server, a computer work-station, and/or a consumer electronic (CE) device. In some embodiments, one or more of the set of customer devices 108 (such as the first customer device 108A, the second customer device 108B and the third customer device 108C) may include a software application (for example, the remote application of the one or more remote applications 110) to remotely control the respective vehicle of the set of vehicles 116.

The one or more remote applications 110 may include logic, interfaces and/or code that may be configured to provide an access to a set of services to remotely control the set of vehicles 116 associated with the first set of customers 106. Examples of the set of services that may be provided by the one or more remote applications 110 may include, but are not limited to, a remote start of the vehicle, a remote locking of the vehicle, a remote unlocking of the vehicle, a light blinking/flashing, and a control of horn of the vehicle. In some embodiments, the one or more remote applications 110 may be compatible with at least the semi-automatic vehicles and the fully automatic vehicles. In an embodiment, the one or more remote applications 110 may a software application, an application programming interface (API), or a web based interface accessed by the set of customer devices 108 to remotely control the set of vehicles 116.

The one or more electronic devices 112 may include suitable logic, circuitry, code and/or interfaces that may be configured to receive recommendation information related to the remote application of the one or more remote applications 110, from the server 102. Examples of the one or more electronic devices 112 may include, but are not limited to, a computing device, a smartphone, a cellular phone, a mobile phone, a mainframe machine, a server, a computer work-station, a laptop computer, a tablet computer, a desktop computer, and/or a CE device.

The communication network 114 may include a communication medium through which the server 102, the customer subscription and application database 104, the set of customer devices 108, and the one or more electronic devices 112 may communicate with each other. The communication network 114 may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the exemplary environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the server 102 may be configured to retrieve the customer subscription data associated with the first set of customers 106 from the customer subscription and application database 104. The first set of customers 106 may be related to the set of vehicles 116 (such as the vehicles associated with a first manufacturing company associated with the server 102). The set of vehicles 116 may be remotely controllable by use of the one or more remote applications 110. The server 102 may be further configured to extract a first set of features from the retrieved customer subscription data from the customer subscription and application database 104.

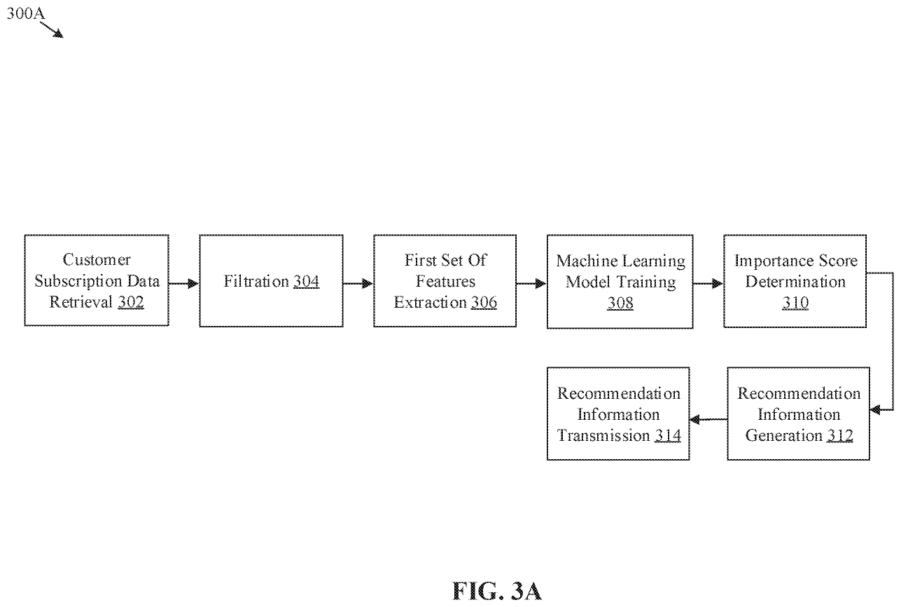

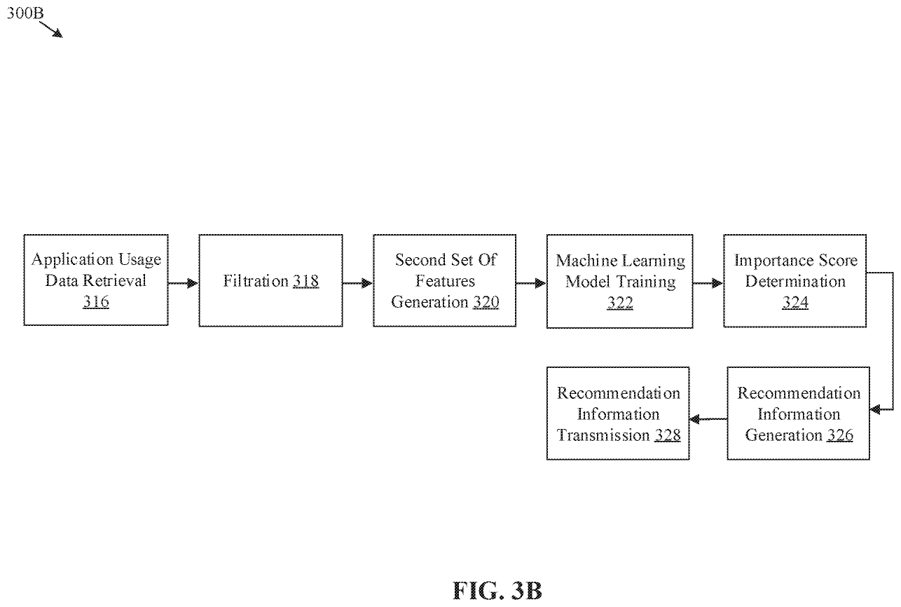

Examples of the first set of features associated with a first customer (such as the first customer 106A) of the first set of customers 106 may include, but are not limited to, an age of the first customer 106A, a gender of the first customer 106A, a usage of a free trial of the remote application of the one or more remote applications 110 by the first customer 106A, registration information of the vehicle (such as a vehicle registration number), a model name of the vehicle purchased by the first customer 106A, a language of the first customer 106A, and an ethnicity of the first customer 106A. The details of the extraction of the first set of features from the retrieved customer subscription data are further provided, for example, in FIG. 3A.

In accordance with an embodiment, the server 102 may be further configured to retrieve the application usage data associated with a usage of the one or more remote applications 110 to control the set of vehicles 116. In some embodiments, the application usage data may be retrieved from the customer subscription and application database 104 or from an external server (not shown in FIG. 1) which may be associated with a third party configured to receive the application usage data from the one or more remote applications 110. The server 102 may be further configured to generate a second set of features, from a plurality of parameters included in the application usage data. Examples of the second set of features may include, but are not limited to, a rate of success of each service of the set of services used by the first customer 106A in the remote application, a date of completion of subscription of the remote application used by the first customer 106A, and a daily usage of a service (for example, the remote start of the vehicle) included in the remote application by the first customer 106A. The details of the generation of the second set of features from the application usage data are further provided, for example, in FIG. 3B.

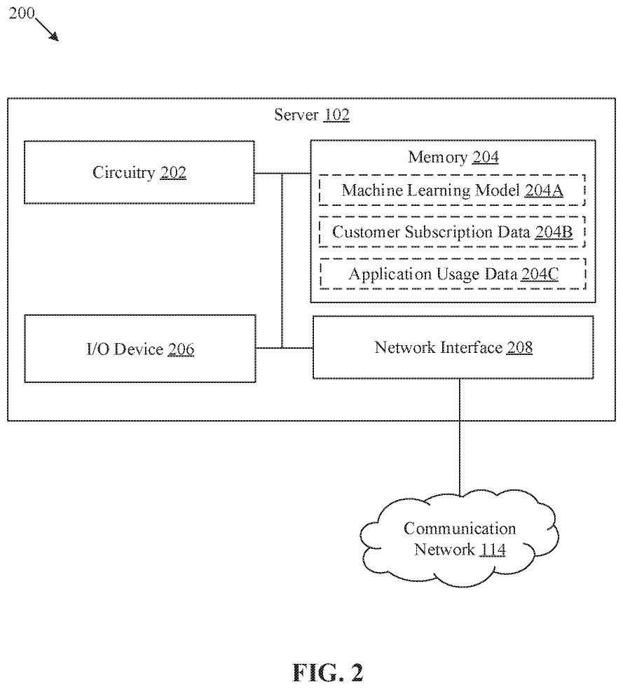

The server 102 may be further configured to train a machine learning model (e.g., a machine learning model 204A of FIG. 2) based on the extracted first set of features and a first feature of the first set of features. The first feature may correspond to a paid subscription of the remote application of the one or more remote applications 110. In some embodiments, the machine learning model (e.g., the machine learning model 204A of FIG. 2) may further be trained based on the generated second set of features and the first feature. In accordance with an embodiment, the machine learning model (e.g., the machine learning model 204A of FIG. 2) may be based on, but is not limited to, a linear regression algorithm or a random forest algorithm. The details of the training of the machine learning model are further provided, for example, in FIGS. 3A-3B.

The server 102 may be further configured to determine an importance score for each of the first set of features and the second set of features based on the trained machine learning model (e.g., the machine learning model 204A of FIG. 2). In accordance with an embodiment, an importance score of a second feature (for example a model name of the vehicle) of a set of features (for example the first set of features and/or the second set of features) may be higher than an importance score of a third feature (for example a year of manufacturing or sales of the vehicle) of the set of features. In such case, an influence of the second feature on the first feature (i.e. paid subscription) is more than an influence of the third feature on the first feature of the set of features. For example, the importance score of the second feature, such as, the usage of the free trial (i.e. free subscription) of the remote application by the first customer 106A, may be greater than the importance score of the third feature, such as, the language of the first customer 106A mentioned in the customer subscription data 204B. The details of the determination of the importance score are further provided, for example, in FIGS. 3A-3B.

The server 102 may be further configured to generate recommendation information related to the remote application of the one or more remote applications 110, based on the determined importance score for each of the first set of features and/or the second set of features. In an embodiment, the recommendation information may include at least one of, but not limited to, marketing information to increase the paid subscription of the one or more remote applications 110, or information to enhance one or more technical services of the one or more remote applications 110. The details of the generation of the recommendation information are further provided, for example, in FIGS. 3A-3B.

The server 102 may be further configured to transmit the recommendation information to one or more electronic devices (such as the one or more electronic devices 112) associated with the server 102. For example, the one or more electronic devices may be associated with a technical team (such as software team) associated with the server 102 or with the set of vehicles 116, a marketing team associated with the server 102 or with the set of vehicles 116, a research and development team associated with the server 102 and so forth. The details of the transmission of the recommendation information are further provided, for example, in FIGS. 3A-3B.

The server 102 in the present disclosure may enable determination of importance of each feature in the customer subscription data and the application usage data associated with the first set of customers 106 The determined importance in the machine learning model 204A may indicate which features may influence the first set of customers 106 more to purchase the paid subscription (i.e. first feature in the customer subscription data and the application usage data) of the one or more remote applications 110. Thus, the features with a higher importance score may be targeted by, for example, the marketing team and the technical team, such that the paid subscription of the remote application of the one or more remote applications 110 may be strategically marketed to a set of potential customers of the first set of customers 106. Moreover, the server 102 may allow determination of factors that may be useful in technical improvement of the remote application of the one or more remote applications 110. Thus, the recommendation information generated by the disclosed server 102 may help to improve conversion rate of customers to paid subscriptions for the remote application and also help to decrease in the customer churn. This may improve profits of an organization who may sell or market the remote applications, based on sustained and increased revenues from customer subscriptions.

FIG. 2 is a block diagram of an exemplary server for machine learning based recommendations for vehicle remote application, in accordance with an embodiment of the disclosure. FIG. 2 is explained in conjunction with elements from FIG. 1. With reference to FIG. 2, there is shown a block diagram 200 of the server 102. The server 102 may include circuitry 202, a memory 204, an input/output (I/O) device 206, and a network interface 208. The memory 204 may further include a machine learning model 204A, customer subscription data 204B, and application usage data 204C.

The circuitry 202 may include suitable logic, circuitry, and/or interfaces that may be configured to execute program instructions associated with different operations to be executed by the server 102. For example, some of the operations may include training of the machine learning model 204A and determination of the importance score for each of the first set of features and the second set of features based on the trained machine learning model 204A. The operations may further include generation of the recommendation information related to the one or more remote applications 110 based on the determined importance scores. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, and interfaces that may be configured to store the one or more instructions to be executed by the circuitry 202. The memory 204 may be configured to store the machine learning model 204A. The memory 204 may be further configured to store the retrieved customer subscription data 204B and the application usage data 204C associated with the first set of customers 106 and the one or more remote applications 110. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The machine learning model 204A may be a regression model which may be trained to identify a relationship between inputs, such as features in a training dataset (such as, the first set of features of the customer subscription data 204B and the second set of features of the application usage data 204C) and output labels (such as the first feature, i.e. paid subscription). The machine learning model 204A may be defined by its hyper-parameters, for example, number of weights, cost function, input size, number of layers, and the like. The hyper-parameters of the machine learning model 204A may be tuned and weights may be updated so as to move towards a global minima of a cost function for the machine learning model 204A. After several epochs of the training on the feature information in the training dataset, the machine learning model 204A may be trained to output a prediction or a classification result for a set of inputs. The prediction result may be indicative of a class label for each input of the set of inputs (e.g., input features extracted from new/unseen instances).

The machine learning model 204A may be a computational network or a system of artificial neurons, arranged in a plurality of layers, as nodes. The plurality of layers of the machine learning model 204A may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the machine learning model 204A. Such hyper-parameters may be set before or while training the machine learning model 204A on a training dataset.

Each node of the machine learning model 204A may correspond to a mathematical function (e.g., a sigmoid function or a rectified linear unit) with a set of parameters, tunable during the training of the machine learning model 204A. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the machine learning model 204A may correspond to same or a different same mathematical function.

In training of the machine learning model 204A, one or more parameters of each node of the machine learning model 204A may be updated based on whether an output of the final layer for a given input (from the training dataset) matches a correct result based on a loss function for the machine learning model 204A. The above process may be repeated for same or a different input till a minima of loss function may be achieved and a training error may be minimized. Several methods for training are known in art, for example, gradient descent, stochastic gradient descent, batch gradient descent, gradient boost, meta-heuristics, and the like.

The machine learning model 204A may include electronic data, such as, for example, a software program, code of the software program, libraries, applications, scripts, or other logic or instructions for execution by a processing device, such as the circuitry 202 of the server 102. The machine learning model 204A may include code and routines configured to enable a computing device, such as the circuitry 202 to perform one or more operations for the generation of the importance score for each of the first set of features and the second set of features. Additionally, or alternatively, the machine learning model 204A may be implemented using hardware including a processor, a microprocessor (e.g., to perform or control performance of one or more operations), a field-programmable gate array (FPGA), or an application-specific integrated circuit (ASIC). Alternatively, in some embodiments, the machine learning model 204A may be implemented using a combination of hardware and software.

In an embodiment, the machine learning model 204A may include at least one of, but not limited to, a logistic regression model and a random forest model. In an embodiment, the logistic regression model may correspond to a regression model that may be used to analyze a relationship between a binary dependent variable and one or more independent variables. The analysis associated with the logistic regression model may be based on estimation of logarithmic odds of an event, which may correspond to the binary dependent variable assuming a certain Boolean value (e.g., a true value or a false value). In an embodiment, the logistic regression model may include a plurality of linear regression functions, whose summation may correspond to the estimation of the logarithmic odds of the event.

In an embodiment, a random forest model may be a classifier that may include a plurality of decision trees, which may be trained on different sub-sets of a training dataset (such as the first set of features and/or the second set of features) associated with the random forest model. The random forest model may take an average or a vote of classification outputs of each constituent decision tree to determine a final output (such as the first feature, i.e. paid subscription), which may have a higher accuracy. A higher the number of the decision trees associated with random forest model, a higher may be an accuracy and a lower may be an overfitting of output, associated with the random forest model.

In certain embodiments, the machine learning model 204A may be based on a neural network model. Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), (You Only Look Once) YOLO network, a Long Short Term Memory (LSTM) network based RNN, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), a Graphical Neural Network (GNN), and/or a combination of such networks. In some embodiments, the machine learning model 204A may include numerical computation techniques using data flow graphs. In certain embodiments, the machine learning model 204A may be based on a hybrid architecture of multiple Deep Neural Networks (DNNs).

The I/O device 206 may include suitable logic, circuitry, and interfaces that may be configured to receive an input and provide an output based on the received input. For example, the I/O device 206 may receive a user input to initiate an analysis on the customer subscription data 204B and the application usage data 204C to train the machine learning model 204A and determine the importance scores for the first set of features and the second set of features. The user input may correspond to filtering of the customer subscription data 204B or the application usage data 204C based on one or more predefined rules. In another example, the I/O device 206 may output the determined importance scores and the generated recommendation information. The I/O device 206 which may include various input and output devices, may be configured to communicate with the circuitry 202 of the server 102. Examples of the I/O device 206 may include, but are not limited to, a touch screen, a keyboard, a mouse, a joystick, a microphone, a display device, and a speaker.

The network interface 208 may include suitable logic, circuitry, and interfaces that may be configured to facilitate communication between the server 102, the customer subscription and application database 104, the set of customer devices 108, and the one or more electronic devices 112, via the communication network 114. The network interface 208 may be implemented by use of various known technologies to support wired or wireless communication of the server 102 with the communication network 114. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The functions or operations executed by the server 102, as described in FIG. 1, may be performed by the circuitry 202. Operations executed by the circuitry 202 are described in detail, for example, in FIGS. 1, 3A, 3B, 5, and 6.

FIGS. 3A-3B collectively illustrate exemplary operations for machine learning model based recommendations for vehicle remote application, in accordance with an embodiment of the disclosure. FIGS. 3A-3B are explained in conjunction with elements from FIGS. 1 and 2. With reference to FIG. 3A, there is shown a sequence diagram 300A to depict exemplary operations from 302 to 314. The exemplary operations illustrated in the sequence diagram 300A may start at 302 and may be performed by any computing system, apparatus, or device, such as by the circuitry 202 of the server 102.

At 302, the customer subscription data 204B may be retrieved. In accordance with an embodiment, the circuitry 202 may be configured to retrieve the customer subscription data 204B from the customer subscription and application database 104. Moreover, in some embodiments, the memory 204 may store the customer subscription data 204B upon the retrieval. The customer subscription data 204B may include information related to the first set of customers 106, such as, information associated with a purchase of at least one vehicle associated with the server 102 by each of the first set of customers 106. The set of vehicles 116 associated with the first set of customers 106 may be remotely controllable by the one or more remote applications 110 associated with the server 102.

In an exemplary embodiment, the customer subscription data 204B associated with the first customer 106A may include information related to the first customer 106A, such as, but not limited to, a name of the first customer 106A, a photograph of the first customer 106A, an identification proof (such as, a social service number) of the first customer 106A, residence information of the first customer 106A, and a mode of payment selected by the first customer 106A for purchase of a vehicle. Similarly, the customer subscription data 204B associated with the second customer 106B may include information related to the second customer 106B, such as, but not limited to, the name of the second customer 106B, the photograph of the second customer 106B, the identification proof of the second customer 106B, the residence information of the second customer 106B, and the mode of payment selected by the second customer 1066 for purchase of a vehicle. The customer subscription data 204B may include a plurality of data records, where each data record may include the information related to one of the first set of customers 106. In an embodiment, the customer subscription data 204B may further include information about the first set of features. In such case, the customer subscription data 204B may include information such as, but not limited to, a usage of a free subscription of the remote application to control a vehicle by each customer, registration information of the vehicle, a model name of the vehicle purchased by each customer, a year of manufacturing/sales of the vehicle purchased by each customer, a language of each customer, an ethnicity of each customer, information about a number of members in a family of each customer, a census area associated with each customer, a technology preference of each customer for usage of the remote application, or usage of the first feature by each customer. Details and examples of the first set of features are further provided, for example, at 306 in FIG. 3.

In accordance with an embodiment, the one or more remote applications 110 may be installed on a customer device associated with each of the first set of customers 106. For example, the vehicle purchased by each of the first set of customers 106 may be compatible with the one or more remote applications 110. The one or more remote applications 110 may be installed on the customer device (such as the first customer device 108A, the second customer device 108B, and the third customer device 108C) associated with the respective first set of customers 106, for example, the first customer 106A, the second customer 106B and the third customer 106C. In an exemplary scenario, the one or more remote applications 110 may be installed on the one or more of the set of customer devices 108 after purchase of the respective vehicle by the one or more first set of customers 106.

In accordance with an embodiment, the one or more customers of the first set of customers 106 may be subscribed to the one or more remote applications 110 to control the set of vehicles 116. In an exemplary scenario, a subscribed remote application installed on a customer device of a customer may enable the customer to remotely control a vehicle associated with the customer. For example, the first remote application 110A (when installed and subscribed) on the first customer device 108A of the first customer 106A may enable the first customer 106A to remotely control a first vehicle 116A (shown in FIG. 1) associated with the first customer 106A. Similarly, the second remote application 1106 (when installed and subscribed) on the second customer device 1086 of the second customer 1066 may enable the second customer 106B to remotely control a second vehicle 116B (shown in FIG. 1) associated with the second customer 1066. The subscription of the one or more remote applications 110 may be a free subscription or a paid subscription of the one or more remote applications 110. In some embodiments, the free subscription of the one or more remote applications 110 may be provided for a pre-determined period, e.g., 90 days for usage of the one or more remote applications 110 in a trial mode after the purchase of the vehicle. In one or more embodiments, the paid subscription of the one or more remote applications 110 may be provided for another pre-determined period, e.g., on a half yearly basis or a yearly basis, based on a payment of a subscription fee after expiration of the free subscription or directly after the purchase of the vehicle. In accordance with an embodiment, information about the subscription (such as free subscription or paid subscription) of the remote application (i.e. used by the first set of customers 106) is included in the customer subscription data 204B. Such information may be referred as the first feature in the first set of features and the second set of features.

At 304, the retrieved customer subscription data 204B may be filtered. In accordance with an embodiment, the circuitry 202 may be configured to filter the retrieved customer subscription data 204B based on one or more predefined rules. The retrieved customer subscription data 204B may be filtered for generation of a subset of the customer subscription data 204B that may be relevant for training of the machine learning model 204A, determination of importance scores, or the determination of the recommendation information for a remote application from the one or more remote applications 110.

In some embodiments, the one or more predefined rules may include, but are not limited to, a rule related to a geographical location of each of the first set of customers 106, a rule related to a date of purchase of each of the set of vehicles 116, or a rule related to an age of each of the first set of customers 106. The one or more predefined rules may further include, but are not limited to, a rule related to a gender of each of the first set of customers 106, a rule related to a model of each of the set of vehicles 116, a rule related to the remote application, a rule related to usage timelines of the remote application, or a rule related to success or failure of the remote application. For example, the customer subscription data 204B may correspond to customers of a plurality of geographical locations, such as United States of America, Canada, and the like. The customer subscription data 204B may be filtered such that the customer subscription data 204B corresponding to the customers of the geographical location of United States of America may be selected. In another example, the customer subscription data 204B corresponding to the customers who are “male and above the age of 40” may be selected. In an exemplary scenario, the customer subscription data 204B may be filtered based on the date of purchase of the vehicles such that the filtered customer subscription data 204B may include data corresponding to the customers who may have purchased one or more vehicles in a span of last one year. Similarly, the customer subscription data 204B corresponding to the customers who may use a particular model of the set of vehicles 116 may be selected or filtered. Thus, a target data may be filtered by the disclosed server 102 from all of the customer subscription data 204B or the application usage data 204C in the customer subscription and application database 104 based on a preference of a user associated with the server 102. Such filtered data from the customer subscription data 204B or the application usage data 204C may be more relevant for analysis and generation of importance scores and recommendations.

At 306, the first set of features may be extracted. In accordance with an embodiment, the circuitry 202 may be configured to extract the first set of features from the retrieved customer subscription data 204B. In some embodiments, the first set of features may be extracted from (or based on) the filtered customer subscription data 204B. The extracted first set of features and exemplary customer subscription data 204B are depicted in Table 1, as follows:

TABLE 1
Customer subscription data and First set of features

| | First | Second | Third | Nth |
|---|---|---|---|---|
| First Set of | Customer | Customer | Customer | Customer |
| Features | 106A | 106B | 106C | 106N |
| Age | 34 | 25 | 48 | 62 |
| No. of family | 4 | 2 | 3 | 5 |
| members | | | | |
| Gender | Male | Female | Female | Male |
| Ethnicity | French | African | North | South Asian |
| | Canadian | American | American | |
| Language | French | English | English | Chinese |
| Vehicle model | ABC | EFG | MNP | XYZ |
| name | | | | |
| Year of | 2019 | 2018 | 2018 | 2019 |
| manufacturing | | | | |
| of vehicle | | | | |
| Registration | ACT12GT | AB35FG | Q15620 | AV0234 |
| of Vehicle | | | | |
| Census area | Pacific | East south | South | New England |
| | | central | Atlantic | |
| Computer | Yes | Yes | Yes | No |
| usage | | | | |
| Technology | Smartphone | Computer | Laptop | Smartphone |
| preference | | | | |
| Usage to free | Yes | Yes | No | Yes |
| subscription | | | | |
| Usage of paid | Yes | No | No | Yes |
| subscription | | | | |
| (i.e. First | | | | |
| Feature) | | | | |

In accordance with an embodiment, the first set of features associated with each of the first set of customers 106 may include, but are not limited to, an age of each customer, a usage of a free subscription of the remote application to control a vehicle by each customer, registration information of the vehicle, or a model name of the vehicle purchased by each customer. The first set of features may further include, but are not limited to, a year of manufacturing or sales of the vehicle purchased by each customer, a language of each customer, an ethnicity of each customer, information about a number of members in a family of each customer, a census area associated with each customer, a technology preference of each customer for usage of the remote application, or usage of the first feature by each customer (as depicted in Table 1). It may be noted that the data (i.e. customer subscription data 204B and the first set of features) provided in Table 1 may merely be taken as experimental exemplary data and may not be construed as limiting the present disclosure.

In an exemplary scenario, the first set of features associated with the first customer 106A may indicate the age of the first customer 106A, i.e., “34 years”, the number of members in the family of the first customer 106A, i.e., “4”, the gender of the first customer 106A, i.e., “a male”, the ethnicity of the first customer 106A, i.e., “French American” and the language (such as a primary language) of the first customer 106A, i.e. “French”. Furthermore, the first set of features associated with the first customer 106A may indicate the model name of the vehicle purchased by the first customer 106A i.e., “ABC”, the year of manufacturing of the vehicle purchased by the first customer 106A i.e., “2019”. In some embodiments, the first set of features may further include a year of purchase of the vehicle by the first customer 106A. The first set of features associated with the first customer 106A may further include the census area associated with a residence of the first customer 106A, i.e., “Pacific region”. The features “computer usage” and “technology preference” associated with the first customer 106A may indicate an interest and/or a level or comfort of the first customer 106A towards use of technology.

In an embodiment, the first set of features may further include the usage of the free subscription of the remote application as a feature extracted from the customer subscription data 204B. The feature “usage of the free subscription” may be based on a previous use of the free subscription of the remote application. In other words, such feature or information in the customer subscription data 204B for the first customer 106A may indicate that the first customer 106A may have used the free subscription (or trial subscription) of the remote application to control the corresponding vehicle. In an embodiment, the feature “usage of the paid subscription of the remote application” may correspond to the first feature of the first set of features. The first feature for the first customer 106A may indicate that the paid subscription of the remote application is currently or recently used by the first customer 106A. For example, for the first customer 106A, the “Usage to free subscription” feature and “Usage of paid subscription” feature (i.e. the first feature) in Table 1 indicates that the first customer 106A used the free subscription and then shifted to the paid subscription of the remote application to control the corresponding vehicle remotely using the remote application installed on the first customer device 108A. In another example, the second customer 1066 does not convert to the paid subscription from the free subscription of the remote application for the vehicle (i.e. with model name “EFG” as shown in Table 1). In another example, the third customer 106C never subscribed to either of the free subscription or paid subscription of the remote application to remotely control the vehicle (i.e. with model name “MNP” as shown in Table 1). In accordance with an embodiment, the circuitry 202 may access or analyze the retrieved customer subscription data 204B to extract the first set of features for each customer mentioned in the customer subscription data 204B. In some embodiments, each customer of the first set of customers 106 are registered or subscribed to the server 102 or to an owner of the server 102, where the owner may be a manufacturing organization of the set of vehicles 116 purchased or owned by the first set of customers 106.

At 308, the machine learning model 204A may be trained. In accordance with an embodiment, the circuitry 202 may be configured to train the machine learning model 204A based on the extracted first set of features and the first feature as depicted, for example, in Table 1. The machine learning model 204A may be trained by the circuitry 202 to determine the impact of the first set of features on the first feature (i.e. paid subscription) to further determine importance scores for the first set of features and generate the recommendation information. The usage of the paid subscription of the remote application by the first set of customers 106 may be dependent on one or more of the first set of features, such that a few features of the first set of features may impact the usage of the paid subscription (or conversion to the paid subscription) more than remaining features of the first set of features. In other words, certain features in the customer subscription data 204B may contribute more for the paid subscription (i.e. first feature) in the customer subscription data 204B. For example, the age of the first set of customers 106 may be a relevant or impactful factor in the customer subscription data 204B, that may indicate that a probability of the paid subscription (i.e. first feature) for the age feature is high or not. In another example, based on the analysis of the customer subscription data 204B, the circuitry 202 may determine that most of the customers with gender “male” may have a higher probability to use the paid subscription of the remote application, as indicated by the first feature in the customer subscription data 204B. In such example, the gender feature of the first set of features may be more impactful or relevant feature in the customer subscription data 204B which achieved higher distribution of the paid subscription (i.e. first feature indicated in the customer subscription data 204B). Therefore, based on the analysis of the customer subscription data 204B and the extracted first set of features, the circuitry 202 may determine that most of the first set of customers 106 who have subscribed or transitioned to the paid subscription may lie in a particular age range or may have technology preference (i.e. from computer background) or may use vehicle of a particular model or may reside in a particular location or may have earlier usage of free subscription and so on. Thus, such features which indicates higher probability or distribution of the paid subscription in the customer subscription data 204B may be important features on which the machine learning model 204A may be trained. The trained machine learning model 204A may provide higher importance scores to such features which may indicate higher probability or distribution of the paid subscription in the customer subscription data 204B provided to the machine learning model 204A for training. Details of the training of the machine learning model 204A are provided, for example, in FIG. 2. The important features may further allow determination of potential customers that may be targeted for a conversion to a paid subscription (i.e., the first feature) of the one or more remote applications 110. The details of targeting potential customers based on recommendation information provided by the disclosed server 102 is further described, for example, at 314 in FIG. 3A.

In accordance with an embodiment, the trained machine learning model 204A may include a logistic regression model or a random forest model. In an exemplary scenario, the customer subscription data 204B may include data corresponding to approximately 70000 vehicles of the customers who may belong to the geographical location of the United States of America and Canada. The circuitry 202 may filter (for example based on user inputs) the customer subscription data 204B of the 70000 vehicles to obtain the customer subscription data 204B of the customers who may belong to the geographical location of the United States of America. For example, after the filtration based on the geographical location, the customer subscription data 204B may include data corresponding to approximately 30000 vehicles of the customers. The circuitry 202 may extract the first set of features from the filtered customer subscription data 204B, as depicted in Table 1. The first set of features may be used to train the machine learning model 204A. An exemplary algorithm based on the first set of features to train the machine learning model 204A may be as follows:

First feature ˜(age)+(number of family members)+(gender)+(ethnicity)+(language)+(model of vehicle)+(year of manufacturing)+(census area)+(computer usage)+(technology preference)+(usage of free subscription).

The first feature may correspond to the usage of the paid subscription of the remote application (e.g., the first remote application 110A). The exemplary algorithm may utilize the first set of features to determine the impact of one or more of the first set of features on the first feature. For an example, a value of the first set of features may be a binary value in the form of “0” or “1”. For example, the value for the feature “computer usage” may be “1” if the first customer 106A uses the computer. Similarly, the value of the feature “usage of the free subscription” may also be the binary value. For example, the value for the feature “usage of the free subscription” may be “1” if the first customer 106A has previously used the free subscription of the remote application (e.g., the first remote application 110A). Moreover, the value to the first feature (i.e. usage of paid subscription) may also be the binary value, such that value of the first feature may be “1”, if the first customer 106A uses the paid subscription (i.e. first feature) of the remote application.

In some embodiments, the customer subscription data 204B may include data of the customers that may have started using the free subscription at least a few months prior. For example, the customer subscription data 204B of at least six months prior may be retrieved, to determine the customers of the first set of customers 106 that may have started a usage of the paid subscription (the first feature) after the completion of the free subscription of the remote application (e.g., the first remote application 110A). The circuitry 202 may train the machine learning model 204A based on the first set of features (including, for example, one or more of the first set of features with binary value) and the first feature by use of the logistic regression algorithm. The machine learning model 204A may be trained based on an estimation of a set of coefficients of the logistic regression model, each of which may be indicative of an importance (or impact) of a corresponding feature (i.e. from the first set of features) on the first feature (i.e. paid subscription). A value of a coefficient may indicate the degree of importance (or impact) of the corresponding feature on the first feature; and a sign (positive or negative) may indicate a direction of impact (a directly proportional impact in case of a positive sign and an inversely proportional impact in case of a negative sign). The circuitry 202 may further determine an area under curve (AUC) for the trained machine learning model 204A based on the logistic regression algorithm, that may indicate a degree of success (or a performance score) of the trained machine learning model 204A in a determination of the impact of the first set of features on the first feature. In an exemplary embodiment, the AUC for the machine learning model 204A trained on the exemplary algorithm may be “0.69”. In an example, the AUC of 0.69, which may be close to 1, may indicate that the machine learning model 204A may be successfully trained.

In accordance with an embodiment, the random forest algorithm may be used to train the machine learning model 204A. For example, in the training of the machine learning model 204A, each feature of the first set of features may be removed one at a time from the first set of features, to determine an impact of the remaining first set of features on the value for the first feature or on a probability for the first feature (i.e. paid subscription). Therefore, during the training of the machine learning model 204A, an importance of each feature of the first set of features may be determined. For example, the circuitry 202 may train the machine learning model 204A based on each of the first set of features and may further determine a first performance score (e.g., an AUC) of the trained machine learning model 204A. The circuitry 202 may remove a feature, for example, “age” from the exemplary algorithm and re-train the machine learning model 204A on the remaining of the first set of features. The circuitry 202 may determine a second performance score (e.g., an AUC) of the re-trained machine learning model 204A after the removal of the feature “age”. Further, the circuitry 202 may determine an absolute difference between the first performance score and the second performance score. The absolute difference between the first performance score and the second performance score may be indicative of an importance score of the feature “age” on the first feature, as the removal of the feature “age” may significantly change the value or distribution for the first feature (i.e. paid subscription). Thus, the machine learning model 204A may determine if the age of the first set of customers 106 may impact or influence the value of the first feature or not. The importance score (determined based on the absolute difference between the first performance score and the second performance score) may indicate an importance of the feature “age” without an indication of a direction of impact (e.g., a directly proportional impact or an inversely proportional impact). Similarly, the feature “usage of free subscription” may be removed from the exemplary algorithm to determine the impact or dependence of the feature “usage of free subscription” on the first feature (i.e. paid subscription). The circuitry 202 may further determine the AUC for the trained machine learning model 204A based on the random forest algorithm. For example, the AUC for the trained machine learning model 204A based on the random forest algorithm may be determined as “0.688”. Therefore, the circuitry 202 of the disclosed server 102 may analyze the customer subscription data 204B (i.e. all records for all the customers) to identify the impact or influence of each feature on the first feature. The circuitry 202 may train the machine learning model 204A with respect to the first set of features and the first feature such that the trained machine learning model 204A may provide different importance scores to each of the first set of features based on the impact of each feature on the first feature (i.e. paid subscription) for the selected or filtered customer subscription data 204B. The features which may increase the performance of the machine learning model 204A may be important or impactful to increase the distribution or probability of purchase of the paid subscriptions of the one or more remote applications 110.

At 310, the importance score may be determined. In accordance with an embodiment, the circuitry 202 may be configured to determine the importance score for each of the extracted first set of features based on the trained machine learning model 204A. For example, in case the trained machine learning model 204A corresponds to the logistic regression model, the circuitry 202 may determine the importance score of each feature based on a value of a coefficient corresponding to that feature in the set of linear regression functions associated with the logistic regression model. In another example, in case the trained machine learning model 204A corresponds to the random forest model, the circuitry 202 may determine the importance score of each feature as an absolute difference between a first performance score of the machine learning model 204A and a second performance score of the machine learning model 204A. The first performance score may correspond to an AUC of the machine learning model 204A trained on each of the first set of features. The second performance score may correspond to an AUC of the machine learning model 204A re-trained on the first set of features excluding the feature for which the importance score may be determined. In some embodiments, the importance score may indicate weightage assigned by the trained machine learning model 204A to the first set of features for the prediction of the first feature (i.e. paid subscription) for inputs (such new customer data) provided to the trained machine learning model 204A. The circuitry 202 may be configured to retrieve the importance score for each feature on which the machine learning model 204A may be trained, for the determination of the importance score. Exemplary values for the determined importance score for the first set of features are depicted in Table 2, as follows:

TABLE 2
Importance score for first set of features

| First set of features | Importance score |
|---|---|
| Usage of free subscription (i.e. Rmt_trial) | 0.00869 |
| Model of vehicle | 0.00592 |
| Year of manufacturing | 0.00258 |
| Language | 0.00247 |
| Ethnicity | 0.00193 |
| Age | 0.00135 |
| Census area | 0.00103 |
| Computer usage | 0.00073 |
| Number of family members | 0.00060 |
| Gender | 0.00053 |
| Technology preference | 0.00010 |

In accordance with an embodiment, the importance score of a second feature of the first set of features may be higher than the importance score of a third feature of the first set of features, when an influence of the second feature on the first feature is more than an influence of the third feature on the first feature. For example, with reference to Table 2, the importance score for the feature “model of the vehicle” may be more than the importance score of the feature “year of manufacturing”, and thereby, the impact of the feature “model of the vehicle” may be more than the impact of the feature “year of manufacturing” on the first feature as per the customer subscription data 204B used by the disclosed server 102 to train the machine learning model 204A. As depicted in Table 2, for example, the importance score for the feature “Usage of free trial” may be the highest, which may signify that the impact of the feature “Usage of free trial” may be highest (from amongst the other features in the first set of features) on the first feature. Conclusively, the feature “Usage of free trial” by the first set of customers 106 may be an important factor in a decision of most of the first set of customers 106 to use the paid subscription of the remote application (e.g., the first remote application 110A). The data provided in Table 2 may merely be taken as experimental exemplary data and may not be construed as limiting the present disclosure.

At 312, the recommendation information may be generated. In accordance with an embodiment, the circuitry 202 may be configured to generate the recommendation information related to the remote application (e.g., the first remote application 110A), based on the determined importance score for each of the first set of features. In one or more embodiments, the recommendation information may include marketing information to increase the paid subscription of the one or more remote applications 110, or information to enhance one or more technical services or capabilities of the one or more remote applications 110. The recommendation information may depict the most important features of the first set of features that may be useful in determination of the potential customers that may help in increase of the paid subscription of the one or more remote applications 110.

For example, based on the most important feature (such as the feature “usage of free subscription”) as per Table 2, the recommendation information may include an indication that providing the free subscription to the customers (i.e. who may have never used the remote application or who may be having the vehicle remotely controlled by the remote application) may increase the probability of the customers of buying the paid subscription or corresponding vehicle in future. In an example, when the first set of customers 106 are provided with the free subscription, a likelihood of the first set of customers 106 to purchase the paid subscription may increase by a certain percentage (for example 10%). Thus, the marketing information may include a strategic marketing recommendation, which may indicate that provision of a free subscription of the remote application (e.g., the first remote application 110A) to each of the first set of customers 106 or to new potential customers may improve a conversion rate associated with a paid subscription of the remote application. In another example, based on the importance score for the feature (“model of feature”) as per Table 2, the circuitry 202 may generate the recommendation information which may indicate that a particular model name of the vehicle may have higher impact or distribution of the paid subscription in the customer subscription data 204B, therefore, the marketing of the particular model name of the vehicle may be increased. In another example, the recommendation information may indicate that older age customers may have higher probability or more likely to buy the paid subscription, therefore, older people may be targeted to market the remote application to increase the revenue. In another example, based on the importance score of the feature “computer usage” or feature “Technology preference”, the recommendation information may indicate that computer or technology enthusiasts are more likely to buy the paid subscription, therefore, such people may be targeted to increase the sales for the remote application. Similarly, based on the feature “gender”, the circuitry 202 may generate the recommendation information such as men are more likely to buy the paid subscription, therefore, the marketing of the remote application should be driven more considering men as the potential customers in future. In some embodiments, the recommendation information may include information to enhance the technical services or capabilities of the one or more remote applications 110 which is further provided, for example, in FIG. 3B.

At 314, the recommendation information may be transmitted. In accordance with an embodiment, the circuitry 202 may be configured to transmit the recommendation information to the one or more electronic devices, such as, the one or more electronic devices 112 associated with the server 102. In some embodiments, the one or more electronic devices 112 may be associated with one or more teams such as a sales/marketing team, a technical team, a research and development team or a manufacturing team associated with the server 102 or with the organization of the set of vehicles 116. The one or more teams may utilize the recommendation information as marketing information to increase the sales/revenue for the paid subscription of the remote application (e.g., the first remote application 110A). The one or more teams may further utilize the recommendation information to resolve technical issues in the remote application, as further described in FIG. 3B. In some embodiments, the one or more electronic devices 112 may be associated with the potential customers or people to whom the recommendation information is being transmitted by the disclosed server 102 for marketing. In such case, the recommendation information may include, but is not limited to, promotional offers, discount information, advertisements, gift coupons, o new updates about one or more remote applications or related vehicles which may be remotely controlled by the one or more remote applications.

Although the sequence diagram 300A is illustrated as discrete operations, such as 302, 304, 306, 308, 310, 312 and 314, however, in certain embodiments, such discrete operations may be further divided into additional operations, combined into fewer operations, or eliminated, depending on the particular implementation without detracting from the essence of the disclosed embodiments.

With reference to FIG. 3B, there is there is shown a sequence diagram 300B to depict exemplary operations from 316 to 328. The exemplary operations illustrated in the sequence diagram 300B may start at 316 and may be performed by any computing system, apparatus, or device, such as by the circuitry 202 of the server 102.

At 316, the application usage data 204C may be retrieved. In accordance with an embodiment, the circuitry 202 may be configured to retrieve the application usage data 204C that may indicate a usage of the one or more remote applications 110 to control the set of vehicles 116. The circuitry 202 may retrieve the application usage data 204C from the customer subscription and application database 104 or from the memory 204. In some embodiments, the application usage data 204C may include a plurality of parameters associated with the one or more remote applications 110. The plurality of parameters may include, but is not limited to, a vehicle identification number (VIN) of a vehicle, the model name of the vehicle, the year of manufacturing/sales of the vehicle, the country of residence of a customer, an enrolment date of a customer on the remote application, a usage of a set of services in the remote application, a timestamp of usage of the remote application, or success or failure information of the usage of the set of services of the remote application. In some embodiments, the application usage data 204C may include information about the paid subscription (i.e. first feature) or free subscription of the one or more remote applications 110 taken by the first set of customers 106 to control the set of vehicles 116.

In an exemplary scenario, the plurality of parameters of the application usage data 204C associated with the first customer 106A may include a VIN “ACT12GT” of the vehicle owned, the model name “ABC”, the year of manufacturing “2018” of the vehicle, the country of residence “United States of America” of the first customer 106A, the enrolment date “24 Sep. 2018” of the first customer 106A on the remote application. The plurality of parameters may further include the usage of the set of services (such as “a remote start service”) by the first customer 106A, the timestamp (e.g., “2 Oct. 2018; 15:22:00”) of usage of the remote application, the success or failure information (such as “the remote start was successful”) associated with the set of services of the remote application. In some embodiments, the plurality of parameters may include information about a reason of failure of the remote application to remotely control the vehicle. The reason of failure may be due to several factors, such as, but not limited to, technical problems with the remote application, issue with relevant components or parts of the vehicle, network issue, or issue with an acknowledgement received from the vehicle to the remote application.

In accordance with an embodiment, the set of services included in the remote application may include, but is not limited to, the remote start service of the vehicle, a remote locking service of the vehicle, a remote unlocking service of the vehicle, or a horn blow service of the vehicle. For example, the remote start service of the vehicle may correspond to a remote start of the vehicle of the first customer 106A via the first remote application 110A installed on the first customer device 108A associated with the first customer 106A. The remote locking (or unlocking) service of the vehicle may correspond to a remote locking (or unlocking) of the vehicle of the first customer 106A via the first remote application 110A installed on the first customer device 108A. Similarly, the horn blow service of the vehicle may correspond to a usage of the horn of the vehicle associated with the vehicle of the first customer 106A via the first remote application 110A installed on the first customer device 108A. In some embodiments, the set of services in the remote application may further include, but is not limited to, a security related service, an emergency related service, or a concierge service.

At 318, the application usage data 204C may be filtered. In accordance with an embodiment, the circuitry 202 may be configured to filter the application usage data 204C based on the one or more predefined rules, as described in 304. In an exemplary scenario, the application usage data 204C may be filtered based on a predefined rule that may correspond to a subscription of the remote application by the customer. For example, the application usage data 204C may be filtered to obtain information associated with one or more customers that may be subscribed to the one or more remote applications 110. For example, the application usage data 204C may be retrieved for the first customer 106A, the second customer 1066, and the third customer 106C of the first set of customers 106, based on the predefined rules. In an exemplary embodiment, the predefined rule may correspond to a specific time period. For example, the application usage data 204C associated with one year (for example, for a recent year, or for last two years) of usage may be selected. In another example, the application usage data 204C may be filtered based on the usage timelines of the remote application, such as usage of a particular remote application in last six months. In another example, the application usage data 204C, which may indicate success of the remote application to control the corresponding vehicle, may be selected or filtered based on the rule related to success or failure of the remote application. In another example, the application usage data 204C with respect to a particular model name may be selected for further analysis and determination of the recommendation information. In another example, the application usage data 204C may be filtered based on other plurality of parameters such as country of residence, enrolment date, usage of a particular service, success or failure information.

At 320, the second set of features may be generated. In accordance with an embodiment, the circuitry 202 may be configured to generate the second set of features from the plurality of parameters included in the retrieved application usage data 204C.

The second set of features are depicted in Table 3, as follows:

TABLE 3
Second set of features

| | First customer | Second | Third customer |
|---|---|---|---|
| Second set of features | 106A | customer 106B | 106C |
| Date of completion of | 4^{th} Nov. | 16^{th} Dec. | 20^{th} Aug. |
| subscription | 2019 | 2019 | 2019 |
| Daily Usage of remote | 0.5 | 0.7 | 0.8 |
| start service | | | |
| Daily Usage of remote | 0.8 | 0.3 | 0.5 |
| locking service | | | |
| Daily Usage of remote | 0.8 | 0.3 | 0.4 |
| unlocking service | | | |
| Daily Usage of horn | 0.4 | 0.6 | 0.2 |
| blow service | | | |
| Usage percentage of | 42 | 76 | 87 |
| remote start service | | | |
| Usage percentage of | 84 | 34 | 55 |
| remote locking service | | | |
| Usage percentage of | 84 | 34 | 51 |
| remote unlocking | | | |
| service | | | |
| Usage percentage of | 22 | 56 | 15 |
| horn blow service | | | |
| Success rate of each | 75 | 80 | 78 |
| service (in | | | |
| percentage) | | | |

In accordance with an embodiment, the second set of features may include a rate of success of usage of each service of the set of services in the remote application, the date of completion of subscription of the remote application, daily usage information related to each service included in the remote application, or the usage percentage information of each service included in the remote application, as depicted in Table 3. The data provided in Table 3 may merely be taken as experimental exemplary data and may not be construed as limiting the present disclosure.

In an exemplary scenario, the rate of success of usage of each service of the set of services may be determined based on a ratio of requests successfully completed by the remote application and a total number of requests received from the first customer 106A. For example, in case a total number of requests received from the first customer 106A corresponding to the set of service of the remote application is “16”, and successful requests completed by the remote application for a particular service is “12”, then the rate of success of usage of a particular service may be 12/15, i.e., “75%”, as shown, for example, in Table 3. The circuitry 202 may be configured to generate the feature (i.e. rate of success of usage) based on certain parameters, such as (but is not limited to) the vehicle identification number, the usage of the set of services, success or failure information of the usage, included in the application usage data 204C.

In an embodiment, the date of completion of subscription of the remote application may be based on the completion of the free subscription or the paid subscription of the remote application. The circuitry 202 may be configured to generate the date of completion feature based on, but is not limited to, the parameter “enrolment date” included in the application usage data 204C. The daily usage information related to each service included in the remote application may be determined based on a ratio of a total number of requests for each service received from the first customer 106A and a time length of a first request to a last request made by the first customer 106A in the application usage data 204C. The circuitry 202 may be configured to generate the feature (i.e. daily usage information“) for a particular customer based on the parameters, such as the vehicle identification number, usage of a set of services, timestamp of usage, included in the application usage data 204C. Moreover, the usage percentage information of each service may be determined based on a total number of requests for each service by the first customer 106A and a total number of requests for all services of the set of services. The circuitry 202 may be configured to generate the feature (i.e. usage percentage) based on the parameters, such as (but is not limited to) the vehicle identification number, the usage of a set of services and the timestamp of usage included in the customer subscription data 204B. Thus, the second set of features may be generated to determine a remote application usage pattern of customers, and identify the most used services (or successful service) of the set of services.

At 322, the machine learning model 204A may be trained. In accordance with an embodiment, the circuitry 202 may be configured to train the machine learning model 204A based on the generated second set of features and the first feature (such as the paid subscription of the remote application). In some embodiments, the machine learning model 204A may be trained based on the logistic regression algorithm model or the random forest algorithm model, as described at 308 in FIG. 3A. The machine learning model 204A may be trained to determine an impact of each of the second set of features on the first feature. In an exemplary scenario, the machine learning model 204A may determine an impact of the feature “rate of success of usage” of a service on the paid subscription (i.e. first feature) of the remote application. For example, higher the rate of success of the requested service, higher may be a probability of a customer, such as a first customer 106A, to purchase the paid subscription of the remote application.

In another example, the feature “date of completion” of the subscription may be an important feature to determine the customer subscription behavior for the paid subscription. The service of the remote start of the vehicle may be beneficial for customers that reside in cold geographical locations, therefore, such customers that have the date of completion of subscription of the remote application near winter months (such as between months of December and February), may be more likely to purchase the paid subscription of remote application.

At 324, the importance score may be determined. In accordance with an embodiment, the circuitry 202 may be configured to determine the importance score for each of the generated second set of features based on the trained machine learning model 204A. The determination of the importance score for the first set of features from the trained machine learning model 204A is described, for example, in FIG. 3A, at 310. The importance score may indicate the influence of each of the second set of features on the first feature. The importance score for the second set of features is described with reference to Table 4, as follows:

TABLE 4
Importance score for second set of features

| Second set of features | Importance score |
|---|---|
| Remote start service of the vehicle | 0.589 |
| Rate of success of each service | 0.362 |
| Date of completion of the subscription | 0.050 |

With reference to Table 4, the importance score for the feature “remote start service” may be the highest amongst the other features of the second set of features. This may indicate that the usage of the feature “remote start service” of the vehicle by a customer may be the most important feature for a purchase or conversion to the paid subscription of the remote application. For example, if the first customer 106A may be provided with the free subscription of the remote application, the first customer 106A may be more likely to purchase the paid subscription of the remote application to use the remote start service. Moreover, the feature “rate of success of usage of each service” may have a higher importance score than the feature “date of completion of subscription”, which may indicate that the influence of the feature “rate of success of usage of each service” may be more than the influence of the feature “date of completion of subscription” on the first feature (i.e. paid subscription). For example, the rate of success of the service requests made by the first set of customers 106 may influence the likelihood of the purchase of the paid subscription of the remote application of the one or more remote applications 110. It may be noted that the data provided in Table 4 may merely be taken as experimental exemplary data and may not be construed as limiting the present disclosure.

At 326, the recommendation information may be generated. In accordance with an embodiment, the circuitry 202 may be configured to generate the recommendation information related to the one or more remote applications 110, based on the importance score of each of the second set of features. The recommendation information may include marketing information to increase the paid subscription of the one or more remote applications 110, or information to enhance one or more technical services of the one or more remote applications 110, as described, for example, in FIG. 3A at 312. The recommendation information may provide information related to technical improvements in the remote application. For example, the recommendation information may provide information regarding a service whose rate of success may be the lowest as compared to other services of the set of services. Thus, the information related to technical improvements may be used to enhance the technical services or capabilities of the remote application and thereby also improve a likelihood of the remote application being subscribed through a paid subscription to use the enhanced services by the first set of customers 106. In another example, in case the importance score for the date of completion feature is high for the paid subscription, then the recommendation information may include marketing offers or discounts about the remote application to be sent to the potential customer before the date of completion (for example before the commence of winter season). In another example, in case the importance score for the usage percentage information feature is low, then the recommendation information may include information to conduct a survey with the first set of customers 106 to understand the reason for low usage or include information to resolve technical issues or bugs with the service (or remote application) with low usage percentage.

At 328, the recommendation information may be transmitted. In accordance with an embodiment, the circuitry 202 may be configured to transmit the recommendation information to the one or more electronic devices, such as the one or more electronic devices 112 associated with the server 102. The recommendation information may be transmitted to one or more of the marketing team, the technical team, the research and development team, the manufacturing team, or a service center team associated with the server 102 or with the organization of the set of vehicles 116. In an exemplary scenario, the technical team may utilize the information related to technical improvements to enhance the technical services of the remote application. For example, the technical team may utilize the recommendation information to improve the rate of success of each service of the set of services included in the remote application. In some embodiments, the one or more electronic devices 112 may be associated with the potential customers or people to whom the recommendation information is being transmitted by the disclosed server 102 to conduct survey or resolve technical issues or bugs in the installed remote application. In such case, the one or more electronic devices 112 may correspond to the set of customer devices 108 associated first set of customers 106. In some embodiments, the transmitted recommendation information may be a software update patch to be installed on the corresponding customer device to resolve the issues and enhance the usage or success of the service provided by the remote application.

In an exemplary scenario, the machine learning model 204A may be trained based on the first set of features and the second set of features to determine the importance score for each of the first set of features and the second set of features. The importance score for each of the first set of features and the second set of features may be used to determine the influence of each of the first set of features and the second set of features on the first feature (i.e. paid subscription). The server 102 may enable determination of the important factors related to the first set of customers 106 and the one or more remote applications 110 that may help in increase of the paid subscription of the remote application, increase in the revenues of an organization associated with the server 102, and finally allow increase of the customer satisfaction as well.

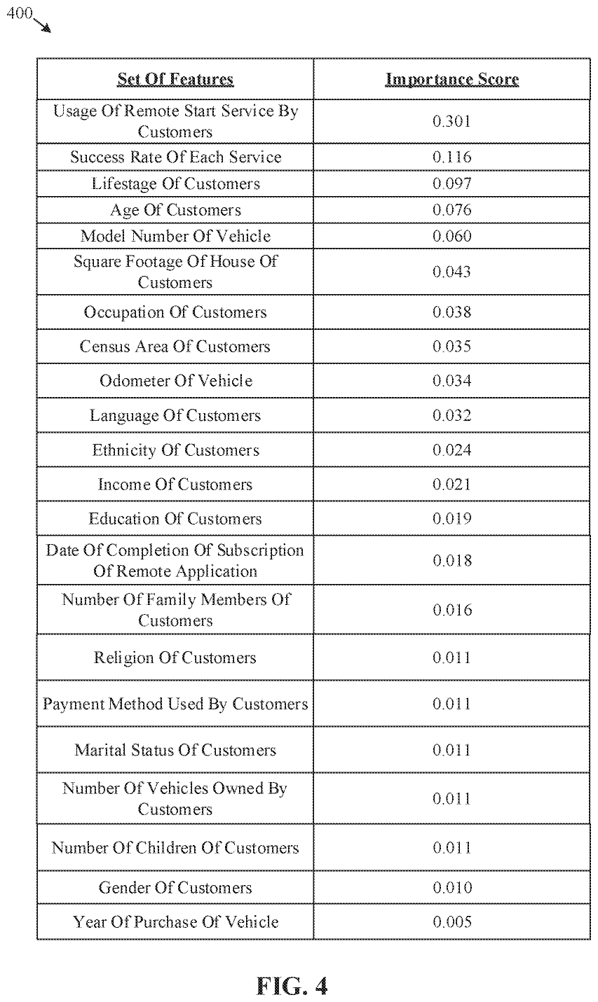

FIG. 4 illustrates an exemplary table which depicts importance scores for first set of features and second set of features, in accordance with an embodiment of the disclosure. FIG. 4 is explained in conjunction with elements from FIGS. 1, 2, 3A, and 3B. With reference to FIG. 4, there is shown a table 400. The table 400 depicts the importance score for each of the first set of features and the second set of features. In an embodiment, the first set of features and the second set of features may be derived from the customer subscription data 204B and the application usage data 204C, and the machine learning model 204A may be trained based on both the first set of features and the second set of features to determine the impact of different features on the paid subscription for the one or more remote applications 110. Therefore, the disclosed server 102 may determine the importance score for each of the first set of features and the second set of features based on such trained machine learning model 204A.

In some embodiments, the circuitry 202 may train the machine learning model 204A on the set of services based on the application usage data 204C and further determine the importance score for each of the set of services. As depicted in Table 400, the service “remote start service” (or the rate of success of the remote start service) may have the highest importance score. The influence of the service “remote start service” may be the highest on the first feature. In an example, the recommendation information generated by the circuitry 202 may indicate to the marketing team that if a free trial subscription of the one or more remote applications 110 have to be provided to the first set of customers 106, then the first set of customers 106 may be encouraged to use the remote start service. This may lead to an increase in conversion rate of the first set of customers 106 to purchase a paid subscription of the one or more remote applications 110. Further, as per Table 4, the feature “rate of success of each service” may be influential for the first feature. The technical team may provide improvement in the technical services to increase the rate of success of the requests received from the first set of customers 106. Improved success rate of the different services may further improve customer satisfaction and thereby reduce customer churn. This may further improve the revenues of the organization with respect to the increase in the paid subscription of the remote applications provided by the organization to the first set of customers 106 to remotely control the set of vehicles 116.

Thus, the disclosed server 102 may generate different types of the recommendation information based on the machine learning model 204A trained on the first set of features, the second set of features, and the services provided by different remote applications. In an exemplary scenario, the recommendation information may indicate that male customers with age more than 60 years of age may be more likely to purchase the paid subscription of the remote application. Moreover, the customers with specific models of the vehicle such as “Full hybrid electric vehicles (FHEV)” may be more likely to purchase the paid subscription of the remote application. Furthermore, the customers who own a computer or who may be technology enthusiasts may be more inclined towards the paid subscription of the remote application. In an example, the generated recommendation information based on the trained machine learning model 204A may indicate that the customers may be provided the free subscription of the remote application to encourage trial use of the remote application and promote their conversion to paid subscribers of the remote application. Moreover, the customers that reside in the cold geographical regions may be informed about the set of services, such as the “remote start service” of the remote application. Therefore, such probable customers of the first set of customers 106 may be targeted for the purchase the paid subscription of the remote application, based on the determined importance score.

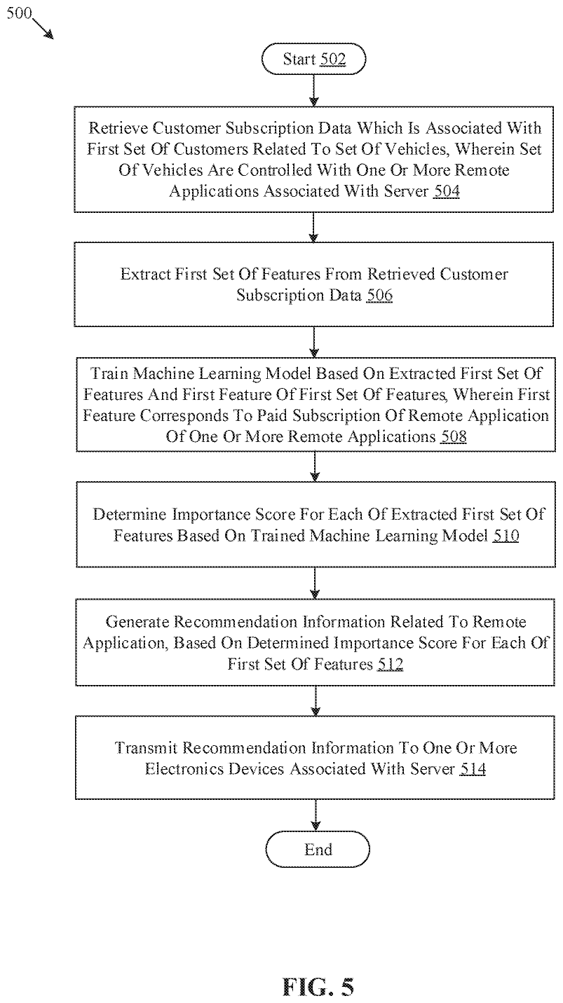

FIG.5 illustrates a first flowchart of an exemplary method for machine learning model based recommendations for vehicle remote application, in accordance with an embodiment of the disclosure. FIG. 5 is explained in conjunction with elements from FIGS. 1, 2, 3A, 3B, and 4. With reference to FIG. 5, there is shown a flowchart 500. The method illustrated in the flowchart 500 may start at 502 and proceed to 504. The method illustrated in the flowchart 500 may be performed by any computing system, apparatus, or device, such as by the circuitry 202 of the server 102.

At 504, the customer subscription data 204B associated with the first set of customers 106 may be retrieved. In an embodiment, the circuitry 202 may be configured to retrieve the customer subscription data 204B from the customer subscription and application database 104. In some embodiments, the circuitry 202 may store the retrieved customer subscription data 204B in the memory 204. The first set of customers 106 may be related to the set of vehicles 116 and the set of vehicles 116 may be controlled with the one or more remote applications 110 associated with the server 102. The retrieval of the customer subscription data 204B is explained further, for example, in FIG. 3A at 302.

At 506, the first set of features may be extracted from the retrieved customer subscription data 204B. In an embodiment, the circuitry 202 may be configured to extract the first set of features from the retrieved customer subscription data 204B. In some embodiments, the first set of features associated with each of the first set of customers 106 may include, but is not limited to, an age of each customer, a usage of a free subscription of the remote application to control a vehicle by each customer, registration information of the vehicle, a model name of the vehicle purchased by each customer, a year of manufacturing of the vehicle purchased by each customer, a language of each customer, an ethnicity of each customer, information about a number of members in a family of each customer, a census area associated with each customer, a technology preference of each customer for usage of the remote application, or usage of the first feature (i.e. paid subscription) by each customer. The extraction of the first set of features from the retrieved customer subscription data 204B is explained further, for example, in FIG. 3A at 306.

At 508, the machine learning model 204A may be trained based on the extracted first set of features and a first feature of the first set of features. In an embodiment, the circuitry 202 may be configured to train the machine learning model 204A based on the extracted first set of features and the first feature of the first set of features. The first feature may correspond to a paid subscription of a remote application of the one or more remote applications 110. In accordance with an embodiment, the trained machine learning model 204A may include at a logistic regression model or a random forest model. The training of the machine learning model 204A based on the extracted first set of features and the first feature is explained further, for example, in FIG. 3A at 308.

At 510, the importance score of each of the extracted first set of features may be determined, based on the trained machine learning model 204A. In an embodiment, the circuitry 202 may be configured to determine the importance score of each of the extracted first set of features, based on the trained machine learning model 204A. In some embodiments, the importance score of a second feature of the first set of features is higher than the importance score of a third feature of the first set of features, when an influence of the second feature on the first feature is more than an influence of the third feature on the first feature. The determination of the importance score of each of the extracted first set of features is explained further, for example, in FIG. 3A at 310.

At 512, the recommendation information related to the remote application (e.g., the first remote application 110A) may be generated. In an embodiment, the circuitry 202 may be configured to generate the recommendation information related to the remote application (e.g., the first remote application 110A). In one or more embodiments, the recommendation information may include marketing information to increase the paid subscription of the one or more remote applications 110, or information to enhance one or more technical services or capabilities of the one or more remote applications 110. The generation of the recommendation information is explained further, for example, in FIG. 3A at 312.

At 514, the recommendation information may be transmitted to the one or more electronic devices associated with the server 102. In an embodiment, the circuitry 202 may be configured to transmit the recommendation information to the one or more electronic devices associated with the server 102. In some embodiments, the recommendation information may be transmitted to the one or more electronic devices 112, via the communication network 114, as described, for example, in FIG. 3A at 314. Control may pass to end.

The flowchart 500 is illustrated as discrete operations, such as 504, 506, 508, 510, 512, and 514. However, in certain embodiments, such discrete operations may be further divided into additional operations, combined into fewer operations, or eliminated, depending on the particular implementation without detracting from the essence of the disclosed embodiments.

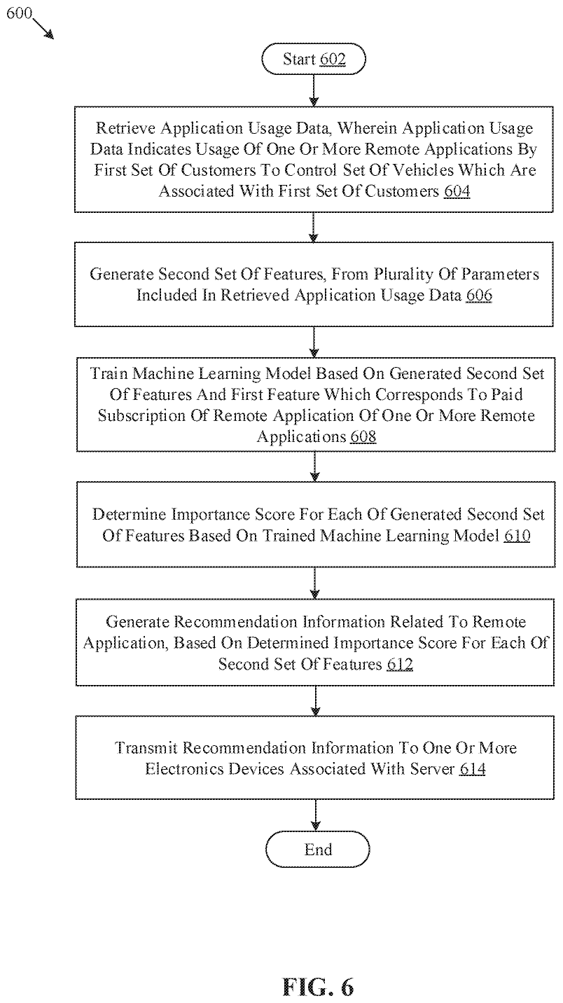

FIG.6 illustrates a second flowchart of an exemplary method for machine learning model based recommendations for vehicle remote application, in accordance with an embodiment of the disclosure. FIG. 6 is explained in conjunction with elements from FIGS. 1, 2, 3A, 3B, 4, 5, and 6. With reference to FIG. 6, there is shown a flowchart 600. The method illustrated in the flowchart 600 may start at 602 and proceed to 604. The method illustrated in the flowchart 600 may be performed by any computing system, apparatus, or device, such as by the circuitry 202 of the server 102.

At 604, the application usage data 204C may be retrieved. In an embodiment, the circuitry 202 may be configured to retrieve the application usage data 204C from the customer subscription and application database 104 or from an external server associated with a third party associated with the one or more remote applications 110.

In some embodiments, the circuitry 202 may store the retrieved application usage data 204C in the memory 204. The application usage data 204C may indicate a usage of the one or more remote applications 110 by the first set of customers 106 (such as the first customer 106A, the second customer 106B and the Nth customer 106N) to control the set of vehicles 116 which may be associated with the first set of customers 106. The retrieval of the application usage data 204C is described further, for example, in FIG. 3B at 316.

At 606, the second set of features may be generated from the plurality of parameters included in the retrieved application usage data 204C. In an embodiment, the circuitry 202 may be configured to generate the second set of features from the plurality of parameters included in the retrieved application usage data 204C. In accordance with an embodiment, the second set of features may include, but is not limited to, the rate of success of usage of each service of the set of services in the remote application, the date of completion of subscription of the remote application, the daily usage information related to each service included in the remote application, or the usage percentage information of each service included in the remote application. In some embodiments, the plurality of parameters associated with the application usage data 204C may include, but is not limited to, a vehicle identification number of the vehicle, the model name of the vehicle, the year of manufacturing of the vehicle, the country of residence, the enrolment date of the customer (such as the first customer 106A) on the remote application, the usage of the set of services in the remote application, the timestamp of usage of the remote application, or success or failure information of the usage of the set of services of the remote application. The generation of the second set of features is described further, for example, in FIG. 3B at 320.

At 608, the machine learning model 204A may be trained based on the generated second set of features and the first feature which corresponds to the paid subscription of the remote application of the one or more remote applications 110. In an embodiment, the circuitry 202 may be configured to train the machine learning model 204A based on the generated second set of features and the first feature indicated in the application usage data 204C. In some embodiments, the trained machine learning model 204A may include at the logistic regression model or the random forest model. The training of the machine learning model 204A based on the generated second set of features and the first feature is described further, for example, in FIGS. 3A and 3B.

At 610, the importance score of each of the generated second set of features may be determined, based on the trained machine learning model 204A. In an embodiment, the circuitry 202 may be configured to determine the importance score of each of the generated second set of features based on the trained machine learning model 204A. In some embodiments, the importance score may be determined based on an influence of each feature of the second set of features on the first feature of the first set of features. The determination of the importance score of each of the generated second set of features is described, for example, in FIG. 3B at 324.

At 612, the recommendation information related to the remote application may be generated based on the determined importance score for each of the second set of features. In an embodiment, the circuitry 202 may be configured to generate the recommendation information related to the remote application based on the determined importance score. In one or more embodiments, the recommendation information may include marketing information to increase the paid subscription of the one or more remote applications 110, or information to enhance one or more technical services of the one or more remote applications 110. The generation of the recommendation information is described further, for example, in FIGS. 3A and 3B at 312 and 326.

At 614, the recommendation information may be transmitted to the one or more electronic devices associated with the server 102. In an embodiment, the circuitry 202 may be configured to transmit the recommendation information to the one or more electronic devices 112 associated with the server 102, as described, for example, in FIG. 3B at 328. Control may pass to end.

The flowchart 600 is illustrated as discrete operations, such as 604, 606, 608, 610, 612, and 614. However, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer readable medium and/or storage medium having stored thereon, instructions executable by a machine and/or a computer to operate a server, such as the server 102. The instructions may cause the machine and/or computer to perform operations that include retrieving customer subscription data (e.g., the customer subscription data 204B), which may be associated with a first set of customers (e.g., the first set of customers 106) related to a set of vehicles (such as the set of vehicles 116). The set of vehicles 116 may be controlled by one or more remote applications (e.g., the one or more remote applications 110) associated with the server 102. The operations may further include extracting a first set of features from the retrieved customer subscription data 204B. The operations may further include training a machine learning model (e.g., the machine learning model 204A) based on the extracted first set of features and a first feature of the first set of features. The first feature may correspond to a paid subscription of a remote application of the one or more remote applications 110. The operations may further include determining an importance score for each of the extracted first set of features based on the trained machine learning model 204A. Furthermore, the operations may include generating recommendation information related to the remote application, based on the determined importance score for each of the first set of features. The operations may further include transmitting the recommendation information to one or more electronic devices (such as the one or more electronic devices 112) associated with the server 102.

Various other embodiments of the disclosure may provide a non-transitory computer readable medium and/or storage medium having stored thereon, instructions executable by a machine and/or a computer to operate a server, such as the server 102. The instructions may cause the machine and/or computer to perform operations that include retrieving application usage data (e.g., the application usage data 204C), which may indicate usage of one or more remote applications (e.g., the one or more remote applications 110) by the first set of customers 106 associated with a set of vehicles 116. The one or more remote applications 110 may be associated with the server 102 and the set of vehicles 116 may be controlled by the one or more remote applications 110. The operations may further include generating a second set of features from a plurality of parameters included in the retrieved application usage data 204C. The operations may further include training a machine learning model (e.g., the machine learning model 204A) based on the generated second set of features and a first feature of the first set of features. The first feature may correspond to a paid subscription of a remote application of the one or more remote applications 110. The operations may further include determining an importance score for each of the generated second set of features based on the trained machine learning model 204A. Furthermore, the operations may include generating recommendation information related to the remote application, based on the determined importance score for each of the second set of features. The operations may further include transmitting the recommendation information to one or more electronic devices (such as the one or more electronic devices 112) associated with the server 102.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

1. A server, comprising:
circuitry, wherein the circuitry:
retrieves customer subscription data which is associated with a first set of customers related to a set of vehicles, wherein the set of vehicles are controlled with one or more remote applications associated with the server;
extracts a first set of features from the retrieved customer subscription data;
trains a machine learning model based on;
estimation of a set of coefficients of a regression model, and
the extracted first set of features and a first feature of the first set of features, wherein
the first feature corresponds to a paid subscription of a remote application of the one or more remote applications, and
each coefficient of the set of coefficients indicates an impact of a corresponding feature from the first set of features on the paid subscription of the remote application;
determines an importance score for each of the extracted first set of features based on the trained machine learning model;
generates recommendation information related to the remote application, based on the determined importance score for each of the first set of features; and
transmits the recommendation information to one or more electronic devices associated with the server.

2. The server according to claim 1, wherein the recommendation information includes at least one of: marketing information to increase the paid subscription of the one or more remote applications, or information to enhance one or more technical services of the one or more remote applications.

3. The server according to claim 1, wherein the circuitry further:
filters the retrieved customer subscription data based on one or more predefined rules; and
extracts the first set of features based on the filtered customer subscription data.

4. The server according to claim 3, wherein the one or more predefined rules include at least one of: a rule related to a geographical location of each of the first set of customers, a rule related to a date of purchase of each of the set of vehicles, a rule related to an age of each of the first set of customers, a rule related to a gender of each of the first set of customers, a rule related to a model of each of the set of vehicles, a rule related to the remote application, a rule related to usage timelines of the remote application, or a rule related to success or failure of the remote application.

5. The server according to claim 1, wherein
the importance score of a second feature of the first set of features is higher than the importance score of a third feature of the first set of features, and
an influence of the second feature on the first feature is more than an influence of the third feature on the first feature.

6. The server according to claim 1, wherein the first set of features associated with each of the first set of customers include at least one of: an age of each customer, a usage of a free subscription of the remote application to control a vehicle by each customer, registration information of the vehicle, a model name of the vehicle purchased by each customer, a year of manufacturing of the vehicle purchased by each customer, a language of each customer, an ethnicity of each customer, information about a number of members in a family of each customer, a census area associated with each customer, a technology preference of each customer for usage of the remote application, or usage of the first feature by each customer.

7. The server according to claim 1, wherein the circuitry further:
retrieves application usage data, wherein the application usage data indicates a usage of the one or more remote applications to control the set of vehicles;
generates a second set of features, from a plurality of parameters included in the retrieved application usage data;
trains the machine learning model based on the generated second set of features and the first feature which corresponds to the paid subscription of the remote application of the one or more remote applications;
determines the importance score for each of the generated second set of features based on the trained machine learning model;
generates the recommendation information related to the remote application, based on the determined importance score for each of the second set of features; and
transmits the recommendation information to the one or more electronic devices associated with the server.

8. The server according to claim 7, wherein the plurality of parameters in the application usage data associated with the one or more remote applications include at least one of: a vehicle identification number of a vehicle, a model name of the vehicle, a year of manufacturing of the vehicle, a country of residence, an enrolment date of a customer on the remote application, a usage of a set of services in the remote application, a timestamp of usage of the remote application, or success or failure information of the usage of the set of services of the remote application.

9. The server according to claim 8, wherein the second set of features include at least one of: a rate of success of usage of each service of the set of services in the remote application, a date of completion of subscription of the remote application, daily usage information related to each service included in the remote application, or a usage percentage information of each service included in the remote application.

10. The server according to claim 9, wherein the set of services included in the remote application of the one or more remote applications include at least one of: a remote start service of the vehicle, a remote locking service of the vehicle, a remote unlocking service of the vehicle, or a horn blow service of the vehicle.

11. The server according to claim 1, wherein the trained machine learning model includes at least one of: a logistic regression model or a random forest model.

12. The server according to claim 1, wherein the one or more remote applications are installed on a customer device associated with each of the first set of customers.

13. The server according to claim 1, wherein
one or more customers of the first set of customers are subscribed to the one or more remote applications to control the set of vehicles, and
the subscription of the one or more remote applications includes at least one of: a free subscription or a paid subscription of the one or more remote applications.

14. A server, comprising:
circuitry, wherein the circuitry:
retrieves application usage data, wherein the application usage data indicates a usage of one or more remote applications by a first set of customers to control a set of vehicles which are associated with the first set of customers;
generates a second set of features, from a plurality of parameters included in the retrieved application usage data;
trains a machine learning model based on;
estimation of a set of coefficients of a regression model, and
the generated second set of features and a first feature which corresponds to a paid subscription of a remote application of the one or more remote applications, wherein each coefficient of the set of coefficients indicates an impact of a corresponding feature from the second set of features on the paid subscription of the remote application;
determines an importance score for each of the generated second set of features based on the trained machine learning model;
generates recommendation information related to the remote application, based on the determined importance score for each of the second set of features; and
transmits the recommendation information to one or more electronic devices associated with the server.

15. The server according to claim 14, wherein the plurality of parameters in the application usage data associated with the one or more remote applications include at least one of: a vehicle identification number of a vehicle, a model name of the vehicle, a year of manufacturing of the vehicle, a country of residence, an enrolment date of a customer on the remote application, a usage of a set of services in the remote application, a timestamp of usage of the remote application, or success or failure information of the usage of the set of services of the remote application.

16. The server according to claim 15, wherein the second set of features include at least one of: a rate of success of usage of each service of the set of services in the remote application, a date of completion of subscription of the remote application, daily usage information related to each service included in the remote application, or a usage percentage information of each service included in the remote application.

17. A method, comprising:
in a server:
retrieving customer subscription data which is associated with a first set of customers related to a set of vehicles, wherein the set of vehicles are controlled with one or more remote applications associated with the server;
extracting a first set of features from the retrieved customer subscription data;
training a machine learning model based on;
estimation of a set of coefficients of a regression model, and
the extracted first set of features and a first feature of the first set of features, wherein
the first feature corresponds to a paid subscription of a remote application of the one or more remote applications, and
each coefficient of the set of coefficients indicates an impact of a corresponding feature from the first set of features on the paid subscription of the remote application;
determining an importance score for each of the extracted first set of features based on the trained machine learning model;
generating recommendation information related to the remote application, based on the determined importance score for each of the first set of features; and
transmitting the recommendation information to one or more electronic devices associated with the server.

18. The method according to claim 17, further comprising:
filtering the retrieved customer subscription data based on one or more predefined rules; and
extracting the first set of features based on the filtered customer subscription data.

19. The method according to claim 17, wherein the recommendation information includes at least one of: marketing information to increase the paid subscription of the one or more remote applications, or information to enhance one or more technical services of the one or more remote applications.

20. The method according to claim 17, wherein
the importance score of a second feature of the first set of features is higher than the importance score of a third feature of the first set of features, and
an influence of the second feature on the first feature is more than an influence of the third feature on the first feature.
